(19) United States
(12) Patent Application Publication
(10) Pub. No.: US 2018/0314999 A1
(43) Pub. Date: Nov. 1, 2018

(54) METHODS AND SYSTEMS FOR MANAGING FULLFILLMENT OF ONE OR MORE ONLINE ORDERS

(71) Applicant: Walmart Apollo, LLC, Bentonville, AR (US)

(72) Inventors: Behzad Nemati, Springdale, AR (US); Ehsan Nazarian, Rogers, AR (US)

(73) Assignee: Walmart Apollo, LLC, Bentonville, AR (US)

(21) Appl. No.: 15/964,954

(22) Filed: Apr. 27, 2018

Related U.S. Application Data
(60) Provisional application No. 62/490,739, filed on Apr. 27, 2017.

(51) Int. Cl. G06Q 10/06; G06Q 10/08

(52) U.S. Cl. CPC G06Q 10/06315; G06Q 10/047; G06Q 10/087

(57) ABSTRACT

Systems and methods are provided for fulfilling an online order. The systems and methods include identifying a product and a delivery destination in an online order, identifying at least one distribution center and retail store having the product within a defined radius from the delivery destination, determining a cost for each of the distribution center and retail store to fulfill the online order, and selecting one of the distribution center and retail to fulfill the online order. The cost for filling the online order can be based one or more of a shipping cost for delivery of the product to the delivery destination, a replenishment cost for replenishing the distribution center and retail store with the product a lost sales cost for the distribution center and retail store to ship the product.

### FIELD OF THE INVENTION

The present invention relates to systems and methods for managing fulfillment of one or online orders, and more particularly, systems and methods for managing fulfillment of one or more online orders in a retail setting by one or more retail stores and distribution centers.

### BACKGROUND OF THE INVENTION

Over the past few years, e-commerce has become a vastly popular mechanism for consumers to purchase a wide range of products. As such, many merchants have an online presence along with their brick and mortar stores. Merchants are then able to offer consumers many, if not more, of the products offered in their brick and mortar stores. As such, when consumers submit online orders for one or more products, the merchant can fulfill the online order from an inventory at their distribution center and/or offer pick up from a brick and mortar store. However, the prior art fails to consider the costs of the distribution center and the brick and mortar store fulfilling the online order, such as lost sales costs and replenishment costs. Currently there is no analysis to determine the optimal source from which to supply the products. As such, the estimated delivery date provided to the customer may not be accurate. In addition, the prior art fails to consider the location of the product within the brick and mortar store. Accordingly, embodiments of the present invention solve these problems and provide a more robust representation of the costs and delivery time associated with a given facility fulfilling an online order.

### BRIEF SUMMARY OF THE INVENTION

In some embodiments of the invention, systems for managing fulfillment of one or more online orders can be provided. The systems can include a controller and a processor. The controller can be configured to receive one or more online orders, the online order comprising a product and a delivery destination for delivery of the product. The processor can be in communication with the controller and configured to: identify the product and the delivery destination for the online order, identify at least one distribution center and retail store having the product within a defined radius from the delivery destination, determine a shipping cost for delivery of the product to the delivery destination along with one or more of a replenishment cost for replenishing the distribution center and the retail store with the product and a lost sales cost for the distribution center and retail store to ship the product, and select one of the distribution center and retail store to fulfill the online order the product based upon the shipping cost.

Moreover, the online order can further comprise a method of delivery of the product based on an expected date of delivery of the product. As such, the processor can be configured to identify the method of delivery of the product and determine the shipping cost further based on the method of delivery of the product.

Furthermore, the processor may be further configured to determine a location of the product in the retail store. The location of the product can be on a shelf or in a backroom of the retail store.

In addition, the processor may also be configured to: determine an amount of the products available for shipping in the distribution center and the retail store, determine a time of replenishing the distribution center and the retail store with the product, determine a demand for the product at the distribution center and the retail store. As such, the processor may be configured to determine the shipping cost for the distribution center and the retail store to ship the product to the delivery destination based on the amount of the products available for shipping, the time of replenishing, and the demand for the product

Along these lines, the replenishment cost for the distribution center and retail store can comprise one or more of a transportation cost and a handling cost, and can be based on historical replenishment costs of the product. The lost sales cost for the distribution center and retail store can be based on a probability of having a demand higher than an inventory remaining after shipment of the product and an expected profit from selling the product.

In another embodiment of the invention, a method for managing fulfillment of one or more online order is provided. The method can comprise: receiving, by a computer, one or more online orders, the online orders comprising a product and a delivery destination for delivery of the product; identifying, by the computer, the product and the delivery destination the online order; identifying, by the computer, at least one distribution center and retail store having the product within a defined radius from the delivery destination; determine, by the computer, a shipping cost for delivery of the product to the delivery destination; determine, by the computer, a replenishment cost for replenishing the distribution center and the retail store with the product; determine, by the computer, a lost sales cost for the distribution center and retail store to ship the product; determine, by the computer, a total cost for each of the distribution center and the retail store to fulfill the online order based on the shipping cost, the replenishment cost, and the lost sales cost; and select, by the computer, one of the distribution center and the retail store to fulfill the online order based upon the total cost.

Additional features, advantages, and embodiments of the invention are set forth or apparent from consideration of the following detailed description, drawings and claims.

Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The features and advantages of the invention will be apparent from the following drawings wherein like reference numbers generally indicate identical, functionally similar, and/or structurally similar elements.

In the drawings:

FIG. 1 illustrates an exemplary overall schematic block diagram of a system for managing online orders in accordance with embodiments of the present invention;

FIG. 2 illustrates an exemplary block diagram of distribution centers and retail stores in proximity to a delivery destination in accordance with embodiments of the present invention;

FIG. 3 illustrates an exemplary method for managing online order in accordance with embodiments of the present invention;

FIG. 4 illustrates an exemplary method for managing an online order in accordance with embodiments of the present invention;

FIG. 5 illustrates an exemplary system for managing an online order in accordance with embodiments of the present invention; and

FIG. 6 illustrates an exemplary computing device for managing an online order in accordance with embodiments of the present invention.

### DETAILED DESCRIPTION OF THE INVENTION

Reference will now be made in detail to various embodiments of the present invention, examples of which are illustrated in the accompanying drawings. It is to be understood that the figures and descriptions of the present invention included herein illustrate and describe elements that are of particular relevance to the present invention. It is also important to note that any reference in the specification to “one embodiment,” “an embodiment” or “an alternative embodiment” means that a particular feature, structure or characteristic described in connection with the embodiment is included in at least one embodiment of the invention. As such, the recitation of “in one embodiment” and the like throughout the specification do not necessarily refer to the same embodiment.

The systems and methods in accordance with embodiments of the present invention are intended to manage fulfillment of one or more online orders by one or more distribution centers or retail stores. In the past, retail stores have not been used efficiently to supply products to fulfill deliveries of online orders. When considering what distribution center or retail store to supply products for online orders, the analysis typically focuses on the location closest to the delivery location. Embodiments of the invention now consider a retail store in addition to distribution centers and potential fulfillment sources. In addition, the non-closest retail store or distribution location is also considered. In doing so, the systems and methods utilized are intended to determine the lowest cost of fulfilling an online order from a given facility (i.e., distribution center or retail stores), including providing a short and accurate delivery time and location. As such, one or more retail stores of various distances from the delivery destination of the online order are considered. Moreover, although the systems and methods disclosed herein are intended to be utilized in a retail setting (e.g., a retail store), they can also be utilized in any setting in which one or more products are to be purchased. For instance, the systems and methods disclosed herein can be utilized in a wholesale setting.

The term “consumers,” as used herein, can refer to any purchaser or potentially purchase of a product. As such, consumers are not limited to persons but may also include manufacturers, distributors, and retailers.

The term “distribution center,” as used herein, can refer to any storage facility having an array of products and in charge of processing one or more online orders. The distribution center can ship one or more products directly to retail stores and/or consumers.

The term “retail store,” as used herein, can refer to any retailer or merchant selling products directly to the consumer. As such, the retail store can be a brick and mortar store.

The concepts disclosed herein can also be used to improve the computing systems which are performing, or enabling the performance, of the disclosed concepts. For example, information associated with routes, deliveries, carriers, distribution center inventory or requirements, retail location inventory or requirements, etc., can be generated by local computing devices. In a standard computing system, the information will then be forwarded to a central computing system from the local computing devices. However, systems configured according to this disclosure can improve upon this “centralized” approach.

One way in which systems configured as disclosed herein can improve upon the centralized approach is combining the data from the respective local computing devices prior to communicating the information from the local computing devices to the central computing system. For example, a carrier traveling from a distribution center/retail location to a delivery location may be required to generate information about (1) the route being traveled, (2) space available in the truck for additional goods, (3) conditions within the truck, etc. Rather than transmitting each individual piece of data each time new data is generated, the central server, such as those located on a carrier, can cache the generated data for a period of time and combine the generated data with any additional data which is generated within the period of time. This withholding and combining of data can conserve bandwidth due to the reduced number of transmissions, can save power due to the reduced number of transmissions, and can increase accuracy due to holding/verifying the data for a period of time prior to transmission.

Another way in which systems configured as disclosed herein can improve upon the centralized approach is adapting a decentralized approach, where data is shared among all the individual nodes/computing devices of the network, and the individual computing devices perform calculations and determinations as required. In such a configuration, the central server, such as those located on a carrier, can be in communication with the retail location and/or distribution center, and can make changes to the route, destination, pickups/deliveries, etc., based on data received and processed while in-route between locations. Such a configuration may provide power and/or require more bandwidth than a centralized approach, but can result in a more dynamic system because of the ability to modify assignments and requirements immediately upon making an appropriate determination. In addition, such a system can be more secure, because there are multiple points of failure (rather than a single point of failure in a centralized system).

Yet another way in which system as disclosed herein can improve upon the centralized approach is by implementing a “hybrid” system, which may be more suitable for some specific configurations. In this system, a part of the network/system would be using the centralized approach (which can take advantage of the bandwidth savings described above), while the rest of the system is utilizing a decentralized approach (which can take advantage of the flexibility/increased security described above). For instance, the carriers can be connected to a central server at the distribution center, while the central server is connected to a decentralized network of computers.

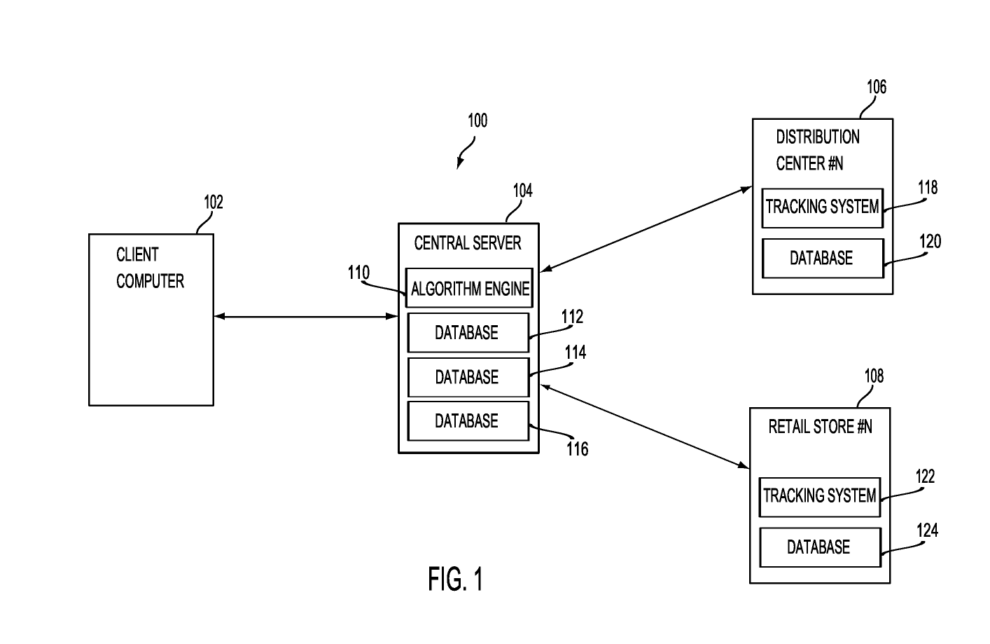

Referring now to FIG. 1, a system 100 for managing fulfillment of one or more online orders is provided. The system 100 can include a client computer 102 in communication a central server 104. The client computer 102 can be any computing device that permits a customer to submit an online order. According to an embodiment, the client computer 102 can be located at a place of business of a seller selling one or more products (e.g., a retail store). As such, the client computer 102 can be in the form of a kiosk or an electronic cash register. According to another embodiment, the client computer 102 can belong to a consumer purchasing one or more products. As such, the client computer 102 can be in the form a home computer, a laptop, a cell phone, a smart phone, or any other computer.

Along these lines, the client computer 102 can be used to generate and submit an online order from a user. The online order can include one or more of a product, a delivery destination of the product, and a method of delivery for the product. According to an embodiment, the online order can comprise a plurality of products to be delivered to a single destination. According to another embodiment, the online order can comprise a plurality of products to be delivered to multiple, different destinations. Moreover, the product can be perishable, and/or can contain an expiration date. As such, exemplary products include, but are not limited to, electronics, movies, clothing, sporting equipment, furniture, food, etc. Further, the method of delivery can comprise one or more levels for shipping based upon a time the product can be delivered. As such, the time can be a range of days or an expected date of delivery of the product. According to an embodiment, the method of delivery can comprise “Basic Shipping” (3-6 business days), “Premium Shipping” (2-3 business days), and “Express Shipping” (1-2 business days).

A central server 104 can be in communication with the client computer 102 and receive the online order. The central server 104 may also be in communication one or more distribution centers 106 and one or more retail stores 108 to fulfill one or more online orders. The distribution center 106 can comprise a tracking system 118 to track one or more products in the distribution center 106 and a database 120 to manage an inventory of products in the distribution center 106. As such, the tracking system 118 can determine if one or more products has been shipped out. Accordingly, when a product is shipped out, the database 120 can update the inventory of the product. These systems and databases may also be combined into a single module or inventory management system.

Similarly, the retail store 108 can comprise a tracking system 122 to track one or more products in the retail store 108 and a database 124 to manage an inventory of products in the retail store 108. The tracking system 120 of the retail store 108 can determine a location of the product, such as on or more shelves and in a backroom. Along these lines, the tracking system 122 can determine if product has been shipped out and/or purchased by a consumer. As such, when a product is shipped out and/or purchased, the database 124 can update the inventory of the product. Again, these systems and databases may also be combined into a single module or inventory management system.

The distribution centers 106 and retail stores 108 can carry the same or different inventories, workloads and/or processing capacities. According to an embodiment, one or more distribution centers 106 may carry a larger inventory of products than one or more retail stores 108. According to another embodiment, one or more of the distribution centers 106 may be able process one or more online orders quicker than one or more retail stores 108.

Moreover, as discussed above, the central server 104 can process an online order. As discussed above, the online order can be received from the client computer 102, and it can be placed online or in a retail store. Alternatively, the online order can be manually inputted by a user into the central server 104. In doing so, the online order can be received by mail or telephone and, therefore, inputted into the central server 104. After receiving the online order, the central server 104 can identify one or more of a product, an identification number of the product (i.e., SKU), a delivery destination of the product, and a method of delivery of the product.

Thereafter, according to an embodiment, the central server 104 can then devise a fulfillment plan to fulfill the online order. In doing so, the central server 104 can identify one or more distribution centers 106 and/or one or more retail stores 108 having one or more products of the online order. As such, the fulfillment plan can include different distribution centers 106 and/or retail stores 108 having different products of the online order. The fulfillment plan can include one distribution center 106 having one or more products and another distribution center 106 having one or more different products. Alternatively, the fulfillment plan can including one retail store 108 having one or more products and another retail store 108 having one or more different products. Yet again, the fulfillment plan can include a distribution center 106 having one or more products and a retail store 108 having one or more different product.

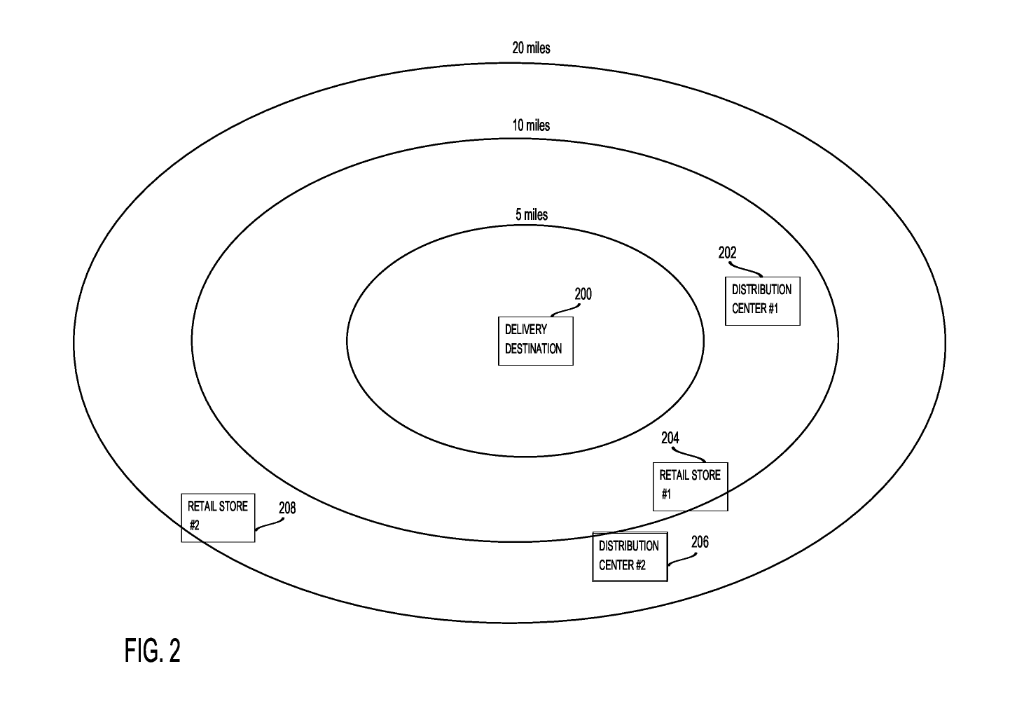

Along these lines, the central server 104 can identify one or more distribution centers 106 and/or retail stores 108 as candidates for fulfilling the fulfillment plan. In doing so, the central server 104 can identify one or more distribution centers 106 and/or retail stores 108 having or not having one or more products of the online order within a distance from the delivery destination. The distance may be a defined radius based on any preselected distance from the delivery destination (i.e., 5 miles, 10 miles, 20 miles, 100 miles, etc.). For example, referring now to FIG. 2, the central server 104 (illustrated in FIG. 1) can identify a first distribution center 202 and retail store 204 having one or more products in an online order, and a second distribution center 206 and retail store 208 not having one or more products, within 10 miles from the delivery destination 200. The first distribution center 102 and retail store 204 are then identified as eligible candidates to supply the products in the online order.

As such, if the distribution center 206 and/or retail store 208 do not have one or more products of the online order, the central server 104 can determine if they will have the product prior to a required delivery time. If they will have the product prior to the required delivery time, the distribution center 206 and/or retail store 208 may still be considered as an eligible candidate. However, if they will not have the product prior to the required delivery time, the distribution center 206 and/or retail store 208 may not be considered an eligible candidate.

Moreover, referring now back to FIG. 1, the central server 104 can determine if fulfilling all or part of the online order from the eligible candidate distribution center 106 and retail store 108 will result in an out-of-stock condition. If the fulfillment of the online order results in an out-of-stock condition, the distribution center 106 and retail store 108 may no longer be considered an eligible candidate for fulfillment of the online order. Accordingly, if there are no eligible candidate distribution centers 106 and/or retail stores 108 to fulfill the online order, the central server 104 may transmit a request to a vendor or supplier to fulfill the online order. However, if the fulfillment of the online order does not result in an out-of-stock condition, the distribution center 106 and/or retail store 108 can be considered an eligible candidate for fulfillment of the online order. In another embodiment, the geographic search for candidate distribution centers 106 and/or retail stores 108 may be expanded if no candidates are found within the specified distance. In such an occurrence, the geographic search for candidate distribution centers 106 and/or retail stores 108 can be expanded a preselected distance from the delivery destination that is greater than the original preselected distance. The preselected distance may an additional 5, 10, or 20 miles.

Along these lines, the central server 104 can continue to determine eligible candidate distribution center 106 and/or retail store 108 until a preselected number of eligible candidates remain. The preselected number of eligible candidate can be any number of distribution centers 106 and/or retail stores 108, such as 1, 5, or 10 eligible distribution centers 106 and/or retail stores 108. According to an embodiment, a preselected number of eligible distribution centers 106 and retail stores 108 must be obtained. According to another embodiment, a preselected number of distribution centers 106, and not retail stores 108, must be obtained. According to another embodiment, a preselected number of retail stores 108, and distribution centers 106, must be obtained.

Once eligible candidates are identified, the central server 104 can determine a cost of supplying one or more products of the online order from each candidate distribution center 106 and/or retail store 106. The cost may be for supplying one item, multiple items, or the entire online order from the candidate location. To determine the cost for supplying one or more products from the online order, the central server 104 can determine one or more of: 1) a cost of shipping one or more products to a delivery destination; 2) a cost for replenishing the candidate distribution center 106 and retail store 108 with the product if shipped from that location; and 3) a cost of lost sales due to shipment of the product, i.e. the product inventory at the fulfillment location is now reduced.

To determine the cost for supplying one or more products from the online order, the central server 104 can comprise an algorithm engine 110, a first database 112 to store cost information of shipping one or more products to the delivery destination, a second database 114 to store cost information for replenishing the candidate distribution center 106 and retail store 108 with the product, a third database 116 to store cost information of lost sales due to shipment of the product. The algorithm engine 110 can determine the cost of supplying the product of the online order from each candidate distribution center 106 and retail store 108 based on the cost information received from each the first database 112, the second database 114, and the third database 116. According to an embodiment, the algorithm engine 110 can determine the cost of supplying the product of the online order for each candidate distribution center 106 and retail store 108 by adding the cost of shipping the product to the delivery destination plus the cost of replenishing the candidate distribution center 106 and retail store 108 with the product plus the cost of lost sales.

As such, the algorithm engine 110 determine the cost of supplying the product of the online order from each candidate distribution center 106 and retail store 108 at one or more predefined times. According to an embodiment, the predefined time can be at a preselected time prior to the purchase of the product. For instance, the preselected time can once a day, a month, a quarter, or year. Alternatively, the preselected time can be each shipment to the candidate distribution center 106 and/or retail store 108. In such an embodiment, the algorithm engine 110 can perform the calculation at the preselected time and elect the appropriate distribution store 106 or retail store 108. This can the algorithm engine 110 to do the calculations prior to purchase, such as days or even months, and readily select the appropriate distribution or retail store 108 upon purchase. According to another embodiment, the predefined time can be upon purchase of the product. By having the cost information stored amongst the first database 112, the second database 114, and the third database 116, the algorithm engine 110 can quickly calculate the cost of supplying the good without noticeably delay. The costs may also be calculated in advance and stored for later access.

The cost of shipping the product can be based on historical data for the same or similar products. For example, the central server 104 can receive shipping cost information from one or more courier providers, such FedEx®, UPS®, and DHL®. To receive accurate cost information, central server 104 can consider the total weight and dimensions of the package holding one or more products. This can allow the system to consider the cost information from multiple different courier providers.

As such, the central server can determine a distance of the candidate distribution center 106 and retail store 108 to the delivery destination. The central server 104 can also determine a method of transporting the product to the delivery destination from each candidate distribution center 106 and retail store 108. Exemplary methods of transporting the product include, but not limited to, ground, air, ship, train, drone, etc. As such, the method of transporting the product can depend on the level of shipment selected by the user. For example, multiple methods of transporting the product can fulfill the time restraints of Basic Shipping (3-6 business days) and Premium Shipping (2-3 business days), whereas fewer methods of transporting the product can fulfill the time restraints of Express Shipping (1-2 business days). Accordingly, the methods of transporting the product can be the same or different for each level of shipment selected by the user. This can allow the central server 104 to provide the cost for shipping the product a number of different methods.

In considering shipping costs, the costs associated with shipping the products individually or as part of entire online order is considered. Shipping costs for each item in the online order from each candidate location may be examined. These costs may be compared with the costs to ship all of or parts of the online order from the same and different candidate locations. Non-closest locations to the delivery location are examined to determine if it is more cost efficient to supply the products from a more distant location. In a simple example, a first candidate distribution center may be located a farther distance from the delivery location than another candidate distribution center. However the first candidate distribution center may have all of the items in the online order, whereas the second, closer candidate distribution center only has six of ten items online ordered. The remaining four items would be supplied from the first or another candidate distribution center. In such a case it may be more cost efficient to have the first candidate distribution center serve as one supply point, rather than incurring the costs associated with multiple deliveries. In some cases it may be more efficient to resupply the second distribution center with the six products, making the overall cost lower to supply from two distribution centers.

To determine the appropriate method of transporting the product, the central server 104 can determine if delivery of the product can be grouped with other online orders to decrease the cost of shipping the product. According to an embodiment, the central server 104 can determine the delivery of the product can be added to one or more existing online orders of the same or different customers. According to another embodiment, the central server 104 can determine if the delivery of the product can be grouped with one or more new online orders.

Also, in determining the cost of shipping the product, the central server 104 can be in communication with the candidate distribution center 106 and retail store 108 to receive the number and/or location of the products in the candidate distribution center 106 and retail store 108. As such, the central server 104 can select a method of shipping the product depending on a demand of the product in the candidate distribution center 106 and/or retail store 108. The demand of the product can be determined by the number of products in the candidate distribution center 106 and/or retail store 108. This can allow the central server 104, candidate distribution center 106, and/or retail store 108 to determine an amount of products purchased over a period of time and a number of items remaining in an inventory of the candidate distribution center 106 and/or retail store 108.

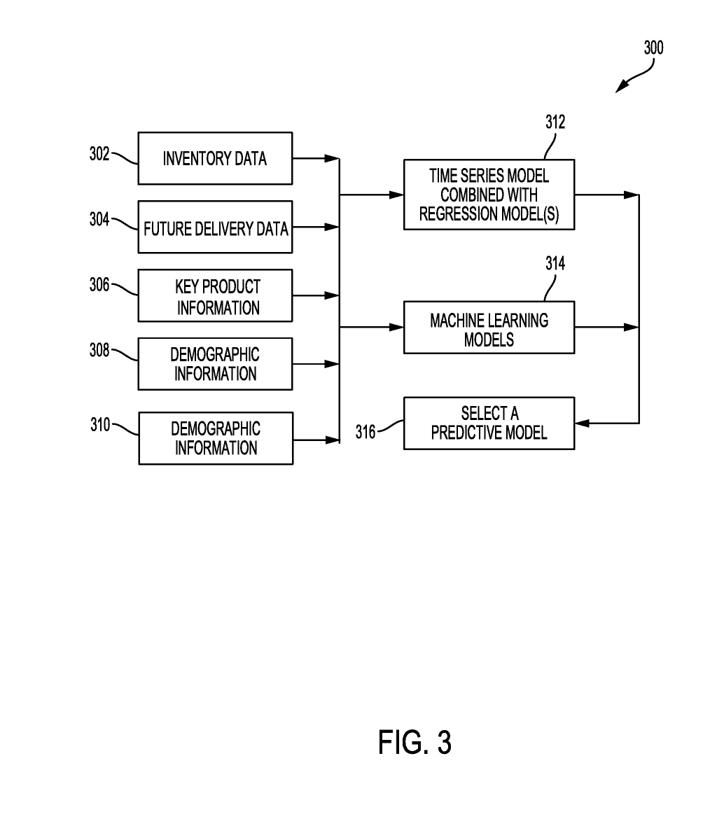

Referring now to FIG. 3, an exemplary flowchart 300 for the central server 104 (depicted in FIG. 1) to determine a demand for product from a candidate distribution store and retail store. The central server 104 can receive one or more of inventory data 302, future delivery data 304 (i.e., receipt of one or more product from producer), key product information 306 (i.e., end of season products, new releases, etc.), historical online order data 308, and demographic information 308. As discussed above, the central server 104 can receive this data at one or more predefined times, including real-time. As such, the central server 104 can perform time series and regression modeling 312 and machine learning model 314 to predict a demand for the product for each candidate distribution store and retail store based on the received data. Upon making the demand predictions, the central server 104 can select a predictive model 316 for each candidate distribution store and retail store.

By doing so, the central server 104, candidate distribution center 106, and/or candidate retail store 108 can determine if shipment of the product will permit the candidate distribution center 106 and/or retail store 108 to have a sufficient amount of products to fulfill existing online orders (i.e., reoccurring online orders) prior to receipt of additional products. Along these lines, the central server 104, candidate distribution center 106, and/or retail store 108 can also determine when the number of products in the candidate distribution center 106 and/or retail store 108 falls below a predetermined number of products. The predetermined number of number can be any preselected amount of the products (i.e., 0, 3, or 5 products).

As a result, if the candidate distribution center 106 and/or retail store 108 does not have a sufficient amount of products to meet demand, shipment of the product can be delayed until receipt of additional products. This allows distribution centers 106 and retail stores 108 currently not having the product or a sufficient number of the products to remain a candidate for fulfilling an online order for the product. Accordingly, if needed, the method of transporting the product can be altered in online order to meet a promised delivery date. For instance, if ground shipping is the standard method of delivery of the product from the candidate distribution center 106 and/or retail store 108 to a delivery destination, but the candidate distribution center 106 and/or retail store 108 will not receive the product for two more days, the method of delivery can be changed to air or train in online order to meet a promised delivery date. However, if the candidate distribution centers 106 and retail stores 108 cannot meet a promised delivery date, they may no longer be considered a candidate for fulfillment of the online order.

Moreover, the cost of shipping one or more product can depend on a location of the products in the distribution center 106 and/or retail store 108. For example, if a product is being processed for a previously placed order in the distribution center 106 and/or retail store 108, priority may be provided to the previously placed order. Similarly, on-shelf availability of an item in a retail store may take priority over fulfilling an online order by removing the item from a store shelf. As such, the central server 104 can receive a location of one or more products in the retail store 108 via the tracking system 122 of the retail store 108. Likewise, the central server 104 can receive a location of one or more products in the distribution center 106 via the tracking system 118 of the distribution center 108.

As stated above, with respect to the retail store 108, the location of product can be either on-shelf or in a backroom, such as a stock room. As such, according to an embodiment, if there are no products in a backroom of the retail store 108 (i.e., only on one or more shelves in the retail store), the retail store 108 may no longer be considered as a possible facility for fulfilling an online order for the product. According to another embodiment, if an amount of products on one or more shelves in the retail store 108 is less than a predetermined number, the retail store 108 may no longer be considered an eligible facility for fulfilling all or part an online order for the product. According to yet another embodiment, if an amount of products in a backroom of the retail store 108 is less than a predetermined number, the retail store 108 may no longer be considered an eligible facility for fulfilling all or part of an online order for the product. The number of products on the shelves or in the backroom of the retail store 108 may be any predetermined number of products, such as 5, 10, 25, or 50 products. Moreover, if the retail store 108 is no longer considered an eligible facility, the central server 104 can then transmit a request to a vendor or supplier to fulfill all or part of the online order. According to yet a further embodiment, the shipping costs of shipping one or more products from retail store 108 can be multiplied by a predetermined number to deter taking one or more products off of the shelves of the retail store 108 to fulfill an online order. The predetermined number can be a marked-up percentage of the original shipping costs, such as 5%, 10% or 20% of the original shipping costs.

To determine the cost of replenishment of a product from the fulfillment location (i.e., the distribution center and/or retail store), the central server 104 can determine an average cost for a candidate distribution center 106 and/or retail store 108 to restock that product. The costs associated with the candidate distribution center 106 and/or retail store 108 receiving one or more products can include one or both of a transportation cost and a handling cost. The cost and other information may be retrieved for all the items received at that location having the same SKU as the online ordered item. Transportation costs refer to expenses incurred in moving products to a different place. Handling costs refer to expenses incurred in storing, shipping, and packing products. According to an embodiment, the average cost for the retail store 108 to receive that product can include an average cost for the retail store 108 to receive the product from the candidate distribution center 106 and an average cost for the candidate distribution center 106 to receive the product from a supplier. According to another embodiment, the average cost for the candidate distribution center 106 to receive the product can include an average cost for the candidate distribution center 106 to receive the product from a supplier. As such, the average cost for the retail store 108 to receive the product can be greater than the average cost for the candidate distribution center 106 to receive the product.

Along these lines, the average cost for a candidate distribution center 106 and/or retail store 108 to receive the product can be examined over a period of time. The period of time can be any predetermined amount of time, such as one week, one month, four months, one year, etc. Alternatively, the average cost for a candidate distribution center 106 and/or retail store 108 to receive the product in an online order can be a rolling average of a plurality of the products previously received by the candidate distribution center 106 and/or retail store 108. The number of products previously received can be any predetermined number of products, such as 5, 10, 20, or 50 products.

For newer items, there may not be a history for shipping costs or other costs. In such cases, similar items may be used as data points. For example, if a new type of shampoo is at issue, the sales history and costs for similar shampoos may be considered. Some factors to be considered in determining similarity may include, shampoos from the same manufacturer, with the same size, cost, product characteristics.

To determine the cost of lost sales due to low inventory, the central server 104 can multiply a probability of having a demand higher than an inventory remaining after fulfilling an online order (current inventory minus one) by an expected profit gained from selling the product instore. To determine the probability of having a demand higher than the inventory remaining after fulfilling the online order, the central server 104 can determine a number of the products previously purchased from the retail store and/or shipped from the candidate distribution center over a period of time. The period of time can be any predetermined amount of time, such as one day, one week, one month, etc. Moreover, the period of time can be based on an expected time of delivery of the products to the candidate distribution center and/or retail store. This can allow the central server to determine if it is worth reducing on-shelf availability in the retail store.

Along these lines, the central server 104 can determine the probability of a demand higher than the inventory remaining after fulfilling the online order. The probability of having a demand higher than the amount of products remaining after fulfilling the online order can be based on an estimated number of products to be purchased from the candidate distribution center and/or retail store over the period of time. The estimated number of products can be based on a historical number of the products purchased over a similar previous period of time. The estimated number of products to be purchased can also be based on forecasted sales for a future period of time. The historical number may be determined based on the sales history of items with the same SKU as the online ordered item. The sale history may be for the same or for similarly situated retails stores or a combination of both. In addition, the day of the week, time of the month and year may also be examined. For example, there may be increased demand for certain products based on seasonal demand, or on paydays or on benefit distribution days (WIC).

According to an embodiment, in an online order for 5 videogame consoles, the closest retail store 108 may have an inventory of 6, and the closest distribution center 106 may have an inventory of 100. Moreover, there may be a 20% change that the retail store 108 will sell more than 1 videogame console prior to receipt of additional videogame consoles, resulting in lost expected profits from having the additional videogame consoles. To expand on the example, there is a 20% chance that until next delivery of the items, the retail store 108 is going to have 2 customers to purchase the console, a 20% chance that 3 customers would make the purchase, and a 10% chance that 4 customers would buy the item. In these cases, the retail store 108 is losing 1, 2, and 3 potential customers, respectively, if they fulfill the online order of 5 that has been submitted. The lost sale in this case would be the amount of revenue/sale expected from potential customer (the price of the console+side purchases typically made alongside the main item, in this case an additional controller and a couple of video games are good examples) times the probability of that scenario happening. In this example, since fulfilling the online order from the closest store might incur lower shipping costs but would actually cost the retailer more due to the lost sale, so the central server 104 might opt to fulfill the online order from the distribution center 108, instead. As such, the central server 104 may determine that although the retail store 108 has lower shipping costs than the distribution center 106, it would actually cost more to ship from the retail store 108 due to the lost sales.

The expected profit gain from purchasing instore can include those related to the product in the online order along with one or more additional products typically sold along with the product instore. For example, if the product purchased in the online order is a video game console, the additional product that can purchased instore can include remote controllers and games. As such, the expected profit can include the gross profit from the video game console as well as the remote controllers and games.

Accordingly, the expected profit from the product can be a price paid by a purchaser for the product minus a cost paid by the candidate distribution center 106 and retail store 108 for the product along with any additional costs incurred. The additional costs incurred by the candidate distribution center 106 can be different than that of the candidate retail store 108. The additional costs for the candidate distribution center 106 can include one or more of storage costs, labor wages, and shipment costs. The additional costs for the candidate retail store 108 can include storage costs, labor costs, shipment costs, on-shelf costs, and advertising costs. As such, the expected profit for the candidate distribution center 106 can be higher than that of the candidate retail store 108.

Moreover, if the cost of supplying one or more products of an online order between a candidate distribution center 106 and retail store 108 is within a predetermined percentage, the central server 104 may look to the location of the products in the retail store 108 and the demand of the product in the distribution center 106 and retail store 108. As stated previously, on-shelf availability of an item in a retail store may take priority over fulfilling an online order by removing the item from a store shelf. As such, if the retail store 108 only has availability on-shelf and will not be able to meet demand without the product, the central server 104 can select the distribution center 106 to supply the product. However, if the retail store 108 only has availability on-shelf and will still be able to meet demand without the product, the central server 104 can select the retail store 108 to supply the product. Yet, if the retail store 108 only has availability on-shelf and will not be able to meet demand without the product and the distribution center 106 also has a demand for the product, the central server 104 can still select the distribution center 106 to supply the product. The predetermined percentage can be 5%, 10%, or 15%.

Along these lines, if the cost of supplying one or more products of an online order between two candidate retail stores 108 is within a predetermined percentage, the central server 104 may look to the location of the products in the retail stores 108 and the demand of the products in the retail store 108. As such, the retail store 108 with the higher chance of not meeting demand without the product will take precedence regardless of the location of the product. Thus, the central server 104 can select the retail store 108 with the lower chance of not meeting demand with the product. The predetermined percentage can be 5%, 10%, or 15%.

Furthermore, the cost of supplying one or more products of an online order between two candidate distribution centers 106 is within a predetermined percentage, the central server 104 may look to the demand of the products in the distribution centers. In doing so, the central server 104 can determine if the distribution centers 106 are supplying one or more retail stores 108 and, more particularly, if the supplied retail stores need the product for on-shelf availability. As such, the distribution center 106 with the higher demand will take precedence. Thus, the central server 104 can select the distribution center 106 with the lower chance of not meeting demand with the product. The predetermined percentage can be 5%, 10%, or 15%.

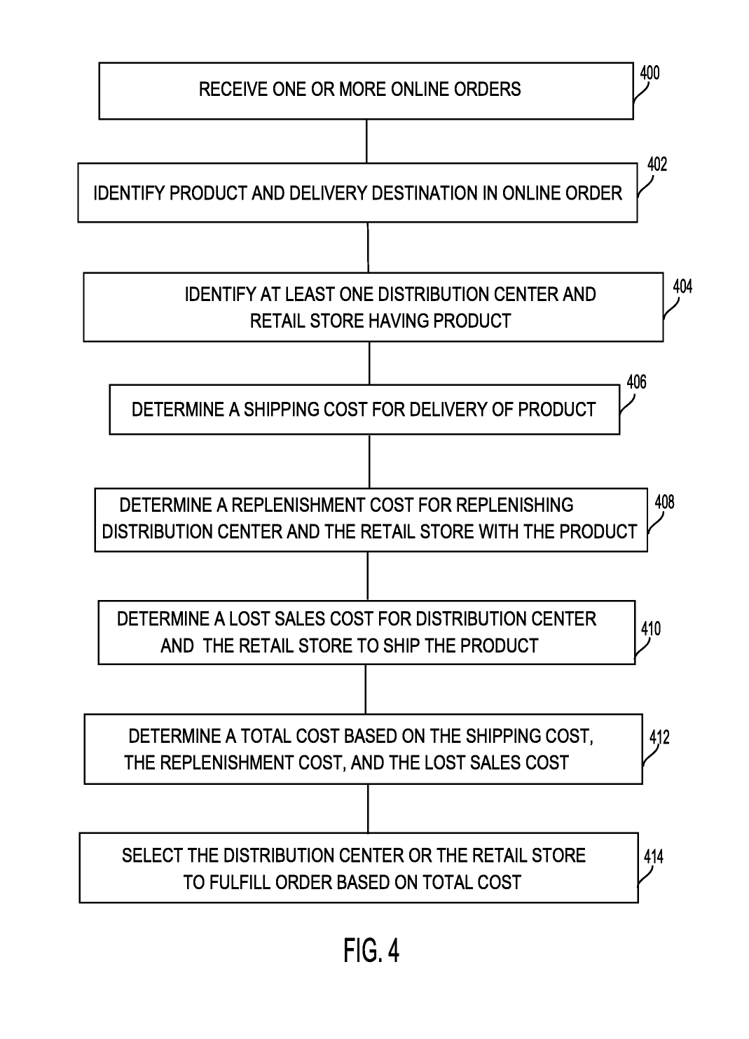

Referring now to FIG. 4 an exemplary method of managing fulfillment of one or more online orders is provided. First, at step 400, a computing device receives one or more online orders. The online order can comprise a product and a delivery destination for delivery of the product. Subsequently, at step 402, the computing device identifies the product and the delivery destination in the online order and, at step 404, identifies at least one distribution center and retail store having the product within a distance from the delivery destination. Next, at step 406, the computing device determines a shipping cost for delivery of the product to the delivery destination. At step 408, the computing device determines a replenishment cost for replenishing the distribution center and the retail store with the product. At step 410, the computing device determines a lost sales cost for the distribution center and retail store to ship the product. Thereafter, the computing device determines a total cost for the distribution center and retail store to fulfill the online order based on the shipping cost, the replenishment cost, and the lost sales cost. Lastly, at step 414, the computing device selects one of the distribution center and retail store to fulfill the online order based upon the total cost.

For example, a customer places an order for a basketball and selects a “2-day shipping” service level for delivery. The order is transmitted to the central server, and the central server identifies the distribution centers and retail stores that deliver the specific brand/model of the basketball based on the geographical information (e.g., customer's address, candidate sources' addresses) and the customer's requested service level. Here, the central server determines that all distribution centers and retail stores can within 100 miles of the customer's location can ship the basketball within 2 days. These are deemed candidates. Next, the central server determines for the replenishment costs for each candidate distribution center and retail store. Here, the replenishment cost for store 120, store 15, and distribution center 34 is $3.50, $10.00, and $1.00, respectively. Subsequently, the central server would determine—(i) the shipping costs between the identified locations and customer's address, and (ii) the loss of sales for shipping the item from the respective location. Here, the shipping cost for store 120, store 15, and distribution center 34 is $10.00, $10.00, and $14.00, respectively, and the lost sales cost is $1.00, $0.50, and $0.00, respectively. Finally, the central server will add all these costs together and select the location with the lowest cost. In this case, the total costs store 120, store 15, and distribution center 34 is $14.50, $20.50, and $15.00, respectively. Thus, the central server would select store 120 as the source and would execute a sales and shipping process for the ordered item to be sent from store 120 to the customer's address.

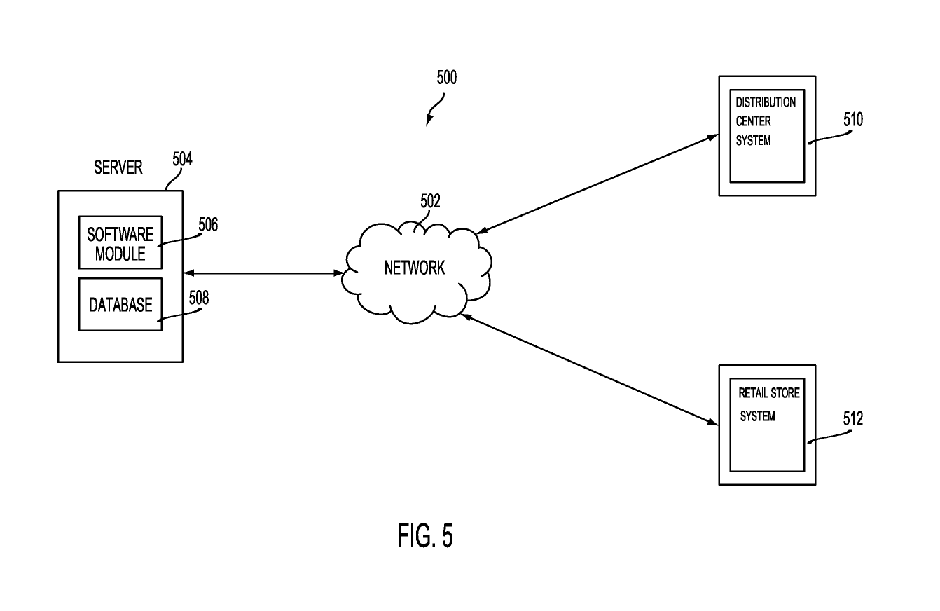

Referring now to FIG. 5, a diagram of an exemplary system 500 is shown that may be utilized in accordance with one or more embodiments of the present invention as discussed above. System 500 can include a network 502, server 504, software module 506, database 508, one or more distribution centers 510, and one or more retail stores 412.

Network 502 can provide network access, data transport and other services to the devices coupled to it in order to send/receive data from any number of user devices, as explained above. In general, network 502 can include and implement any commonly defined network architectures including those defined by standard bodies, such as the Global System for Mobile Communication (GSM) Association, the Internet Engineering Task Force (IETF), and the Worldwide Interoperability for Microwave Access (WiMAX) forum.

Server 504 can also be any type of communication device coupled to network 502, including but not limited to, a personal computer, a server computer, a series of server computers, a mini computer, and a mainframe computer, or combinations thereof. Server 504 can be a web server (or a series of servers) running a network operating system. Server 504 can be used for and/or provide cloud and/or network central.

Software module 506 can be a module that is configured to send, process, and receive information at server 504. Software module 506 can provide another mechanism for sending and receiving data at server 504 besides handling requests through web server functionalities.

Although software module 506 can be described in relation to server 504, software module 506 can reside on any other device. Further, the functionality of software module 506 can be duplicated on, distributed across, and/or performed by one or more other devices, either in whole or in part.

Database 508 can be any type of database, including a database managed by a database management system (DBMS). A DBMS is typically implemented as an engine that controls organization, storage, management, and retrieval of data in a database. DBMS s frequently provide the ability to query, backup and replicate, enforce rules, provide security, do computation, perform change and access logging, and automate optimization.

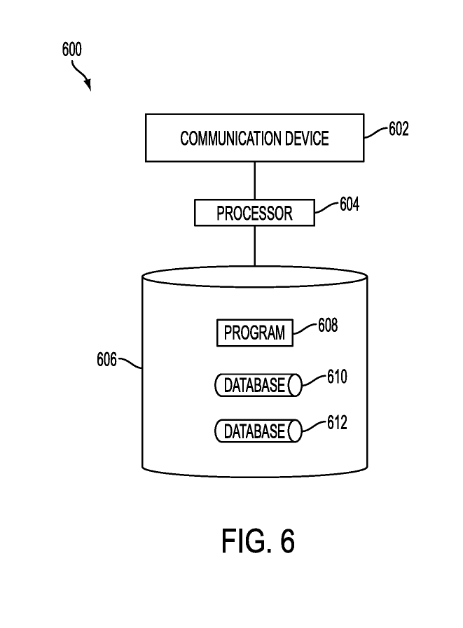

Referring now to FIG. 6, a schematic diagram of an exemplary central server 600 is illustrated in accordance with one or more embodiments of the present invention as discussed above. The exemplary central server 600 includes a processor 604, a communication device 602 and a data storage or memory component 606. The processor 604 is in communication with both the communication device 602 and the memory component 606. The communication device 602 may be configured to communicate information via a communication channel, wired or wireless, to electronically transmit and receive digital data related to the functions discussed herein. The communication device 602 may also be used to communicate, for example, with one or more human readable display devices. The memory component 606 may comprise any appropriate information memory component, including combinations of magnetic memory components (e.g., magnetic tape, radio frequency tags, and hard disk drives), optical memory components, computer readable media, and/or semiconductor memory devices. The memory component 606 may store the program 608 for controlling the processor 604. The processor 604 performs instructions of the program 608, and thereby operates in accordance with the present invention. The memory component 606 may also store and send all or some of the information sent to the processor 604 in one or more databases 610 and 612.

Communication device 602 may include an input device including any mechanism or combination of mechanisms that permit an operator to input information to communication device 602. Communication device 602 may also include an output device that can include any mechanism or combination of mechanisms that outputs information to the operator.

While various exemplary embodiments have been described above, it should be understood that they have been presented by way of example only, and not limitation. Thus, the breadth and scope of the present disclosure should not be limited by any of the above-described exemplary embodiments.

Although the foregoing description is directed to the preferred embodiments of the invention, it is noted that other variations and modifications will be apparent to those skilled in the art, and can be made without departing from the spirit or scope of the invention. Moreover, features described in connection with one embodiment of the invention can be used in conjunction with other embodiments, even if not explicitly stated above.

We claim:

1. A system for managing fulfillment of one or more online orders, the system comprising:
a controller configured to receive one or more online orders, wherein the online order comprises a product and a delivery destination for delivery of said product; and
a processor in communication with said controller and configured to:
identify said product and said delivery destination for said online order;
locate at least one distribution center and retail store having said product within a defined distance from the delivery destination;
determine an amount of said products available for shipping in the distribution center and the retail store;
determine a time of replenishing the distribution center and the retail store with said product;
determine a demand for said product at the distribution center and the retail store;
determine a shipping cost for each of the distribution center and the retail store to ship said product to the delivery destination based on the amount of said products available for shipping, the time of replenishing the product to the distribution center and the retail store, and the demand for said product at the distribution center and the retail store; and
select one of said distribution center and retail store to fulfill the online order for said product based upon said shipping cost.

2. The system of claim 1, wherein the online order further comprises a method of delivery of the product based on an expected date of delivery of the product.

3. The system of claim 2, wherein the processor is further configured to identify the method of delivery of the product and determine the shipping cost further based on the method of delivery of the product.

4. The system of claim 1, wherein the processor is further configured to determine a location of the product in the retail store.

5. The system of claim 4, wherein the location of the product is on a shelf or in a backroom of the retail store.

6. The system of claim 5, wherein the processor is configured to not select the retail store if the product is on the shelf of the retail store.

7. The system of claim 1, wherein the processor is further configured to:
determine a replenishment cost for replenishing the distribution center and the retail store with said product; and
determine a total cost for the distribution center and retail store to fulfill the online order based on the shipping cost and replenishment cost.

8. The system of claim 7, wherein the replenishment cost comprises one or more of a transportation cost and a handling cost.

9. The system of claim 7, wherein the replenishment cost is based on a rolling average of a predetermined number of said products received by the distribution center and retail store.

10. The system of claim 1, wherein the processor is further configured to:
determine a lost sales cost for the distribution center and retail store to ship said product; and
determine a total cost for the distribution center to fulfill the online order based on the shipping cost and lost sales cost.

11. The system of claim 10, wherein the lost sales cost is based on a probability of having a demand higher than an inventory remaining after shipment of the product and an expected profit from selling the product.

12. A system for managing fulfillment of one or more online orders, the system comprising:
a controller configured to receive one or more online orders, wherein the online order comprises a product and a delivery destination for delivery of said product; and
a processor in communication with said controller and configured to:
identify said product and said delivery destination for said online order;
identify at least one distribution center and retail store having said product within a defined radius from the delivery destination;
determine a shipping cost for delivery of said product to said delivery destination;
determine a replenishment cost for replenishing the distribution center and the retail store with said product;
determine a lost sales cost for the distribution center and the retail store to ship said product;
determine a total cost for each of the distribution center and the retail store to fulfill said online order based on the shipping cost, the replenishment cost, and the lost sales cost; and
select one of said distribution center and retail store to fulfill the online order based upon said total cost.

13. The system of claim 12, wherein the processor is further configured to:
determine an amount of said products available for shipping in the distribution center and the retail store;
determine a time of replenishing the distribution center and the retail store with said product; and
determine a demand for said product at the distribution center and retail store demand of said product is based on historical sales of said product over a pre-defined period of time,
wherein the shipping cost is based on the amount of said products available for shipping, the time of replenishing, and the demand for said product.

14. The system of claim 12, wherein the replenishment cost includes one or both of a transportation cost and a handling costs.

15. The system of claim 14, wherein the replenishment cost is based on historical replenishment costs of the product.

16. The system of claim 15, wherein the replenishment cost is a rolling overage of historical replenishment costs of the product.

17. The system of claim 12, wherein the processor is further configured to determine a location of the product in the retail store, and to not select the retail store if the product on a shelf in the retail store.

18. The system of claim 12, wherein the lost sales cost is based on a probability of having a demand higher than an inventory remaining after shipment of the product and an expected profit from selling the product.

19. The system of claim 12, wherein the total cost is the shipping cost is the replenishment cost plus the lost sales cost.

20. A method for managing fulfillment of one or more online orders, the method comprising:
receiving, by a computer, one or more online orders, wherein the online order comprises a product and a delivery destination for delivery of said product;
identifying, by said computer, said product and said delivery destination for said online order;
identifying, by said computer, at least one distribution center and retail store having said product within a defined radius from the delivery destination;
determining, by said computer, a shipping cost for delivery of said product to said delivery destination;
determining, by said computer, a replenishment cost for replenishing the distribution center and the retail store with said product;
determining, by said computer, a lost sales cost for the distribution center and retail store to ship said product;
determining, by said computer, a total cost for each of the distribution center and the retail store to fulfill said online order based on the shipping cost, the replenishment cost, and the lost sales cost; and
selecting, by said computer, one of said distribution center and the retail store to fulfill the online order based upon said total cost.
